(19) United States
(12) Patent Application Publication
(10) Pub. No.: US 2004/0063859 A1
(43) Pub. Date: Apr. 1, 2004

(54) High traction and wear resistant elastomeric compositions

(76) Inventors: Walter H. Waddell, Pasadena, TX (US); Robert R. Poulter, League City, TX (US)

Correspondence Address: ExxonMobil Chemical Company, Law Technology, PO Box 2149, Baytown, TX, 77522-2149, US

(21) Appl. No.: 10/466,178

(22) PCT Filed: Feb. 1, 2002
(86) PCT No.: PCT/US02/03230

(30) Foreign Application Priority Data
Mar. 19, 2001 (US) 60277124

(51) Int. Cl. B60C 13/00; B60C 11/00; C08L 1/00

(52) U.S. Cl. 525/192; 152/209.1; 152/525

(57) ABSTRACT

The present invention is an elastomeric composition having a primary rubber component, a secondary rubber component, and an elastomeric component. More particularly, in one embodiment the elastomeric composition has from 50 to 95 phr natural rubber as the primary rubber component, from 5 to 40 phr of a copolymer of a C₄ to C₇ isoolefin and a para-alkylstyrene as the elastomeric component, and from 0 to 40 phr of polybutadiene as a secondary rubber component. In one embodiment, the copolymer includes a terpolymer of isobutylene, para-methylstyrene and para-bromomethylstyrene, wherein the para-bromomethylstyrene is present from 0.2 mol % to 3.0 mol %. Further, the composition desirably contains carbon black. The compositions are useful for tire treads and tire sidewalls having improved winter wear properties such as high DIN abrasion values and improved Tangent Delta values. The compositions are also useful in any application where high damping and high abrasion resistance is desirable, such as in hoses, belts, antivibrational mounts and shoe soles.

### FIELD OF INVENTION

The present invention relates to elastomeric compositions that are useful in tire treads and tire sidewalls, among other items. More particularly, the present invention relates to blends of a terpolymer of para-bromomethylstyrene, para-methylstyrene, and isobutylene with rubber components such as natural rubber and polybutadiene rubber.

### BACKGROUND OF THE INVENTION

The need for lower cost and higher performing tire tread compounds is on going in the tire industry. In particular, it would be desirable to combine low cost with a tire tread composition versatile enough to be used in both wet traction and winter traction conditions. Although changing the various components that make up a tire is an option, the problem of having one versatile wet/winter tire remains unsolved.

The tread of a tire is typically composed of a blend of rubbers and polybutadiene elastomers, both synthetic and natural. Natural rubber is desirable for its low cost, but often at the sacrifice of dynamic properties. Articles such as tire treads and shoe outsoles require improvements in dynamic properties such as those predictive of traction, while maintaining or improving rolling resistance, service life, and costs. It is known that addition of terpolymers of isoolefin, para-alkylstyrene and para-bromoalkylstyrene to relatively low level natural rubber blends may improve wet traction of tire treads as shown in U.S. Pat. No. 5,063,268, but may reduce the wear life of the tread. U.S. Pat. No. 4,012,344 discloses a tire tread composition having a blend of a highly unsaturated rubber such as natural rubber and an elastomeric copolymer of isobutylene and cyclopentadiene containing at least 5 mol % of cyclopentadiene. Other disclosures of compositions having natural rubber are found in U.S. Pat. Nos. 5,532,312; 5,621,048; 5,994,448 and 6,197,885; and DE 197 31 051. Compositions of elastomers having a high level of natural rubber, greater than or equal to 50 phr, with copolymers or terpolymers of isoolefin, para-alkylstyrene and para-bromoalkylstyrene have not been disclosed.

Having a high degree of natural rubber in a tire tread composition can potentially improve winter traction, but alone, may lower other desirable properties of a tire. What is needed is a low cost composition that can be used for tire treads that has improved winter traction, while maintaining wear resistance. The present invention fulfills this need by providing a composition useful for tire treads and sidewalls that maintains wet traction properties and abrasion resistance, while improving the winter (cold weather) traction of the tire.

### BRIEF DESCRIPTION OF DRAWINGS

FIG. 1 is a plot of the Tangent Delta as a function of Temperature for Sample compositions 1, 4, 5, and 6 of the invention;

FIG. 2 is a plot of the Tangent Delta as a function of Temperature for Sample compositions 1, 2, 3, 6, 9, and 12 of the invention; and

FIG. 3 is a plot of the Tangent Delta as a function of Temperature for Sample compositions 3, 5, 10, 11, and 12 of the invention.

### SUMMARY OF THE INVENTION

The present invention is an elastomeric composition having at least a primary rubber component and an elastomeric component. In a desirable embodiment, the composition also includes a secondary rubber component. More particularly, the elastomeric composition may have from 50 to 95 phr natural rubber as the primary rubber component, from 5 to 40 phr of a copolymer of a C₄ to C₇ isoolefin and a para-alkylstyrene as the elastomeric component, and from 0 to 40 phr of polybutadiene as a secondary rubber component. In one embodiment, the copolymer of a C₄ to C₇ isoolefin and a para-alkylstyrene is terpolymer of isobutylene, para-methylstyrene and para-bromomethylstyrene, wherein the para-bromomethylstyrene is present from 0.2 mol % to 3.0 mol %. Further, the composition desirably contains carbon black. The compositions are useful for tire treads and tire sidewalls having improved properties such as high DIN abrasion values and improved Tangent Delta values. The compositions are also useful in any application where high damping and high abrasion resistance is desirable, such as in hoses, belts, antivibrational mounts, and shoe soles.

### DETAILED DESCRIPTION OF THE INVENTION

Embodiments of the present invention encompass an elastomeric composition containing at least two components: (1) at least one elastomeric component, for example, a terpolymer of an isoolefin, a para-methylstyrene, and brominated para-methylstyrene (BIMS), and (2) at least one rubber such as a natural rubber (NR) as a “primary” rubber component. A third “secondary” rubber component such as a polybutadiene rubber (BR) may be present in a desirable embodiment. In yet another embodiment, the elastomeric composition also has carbon black. The ultimate purpose of the composition is to form tire treads, tire sidewalls, shoe soles and other components where a high degree of wear resistance is desired. Hereinafter in the descriptions, the term “phr” refers to parts per hundreds rubber, as is commonly used in the art. The composition of the elastomer, primary rubber, and, optionally, secondary rubber, may be combined in ratios that are equivalent to 100 phr in one embodiment.

Elastomeric Component

The elastomeric composition contains at least one elastomeric component. The elastomeric component can be copolymers of a C₄ to C₇ isoolefin and a para-alkylstyrene, styrenic compounds, polyurethanes, or blends thereof. Preferably, the elastomeric component of the present invention is an isoolefin/para-alkylstyrene copolymer, wherein the isoolefin is isobutylene. In addition, the para-alkylstyrene is preferably para-methylstyrene. In another embodiment, the elastomeric component is a terpolymer of isobutylene, para-methylstyrene and para-bromomethylstyrene (BIMS), as disclosed in U.S. Pat. No. 5,162,445.

This copolymer or BIMS terpolymer comprises at least 5 phr of the elastomeric composition in one embodiment, and less than 50 phr in another embodiment. Desirably, the BIMS is present from 5 to 40 phr of the elastomeric composition in one embodiment, from 10 to 40 phr in another embodiment, from 10 to 35 phr in yet another embodiment, from 15 to 30 phr in yet another embodiment, from 10 to 30 phr in yet another embodiment, and from 10 to 25 phr in yet another embodiment, wherein a desirable range may be any combination of any upper phr limit with any lower phr limit. Desirable commercial examples of such terpolymers are EXXPRO™ Elastomers (ExxonMobil Chemical Company, Houston Tex.).

The relative amounts of para-alkylstyrene and para-haloalkylstyrene in the copolymer and/or terpolymer can vary widely. Different applications may require different formulations. Generally, the copolymer or terpolymer of the present invention will have from 2 wt % to 20 wt % para-alkylstyrene in one embodiment, and from 3 wt % to 15 wt % in another embodiment, and from 5 wt % to 10 wt % in yet another embodiment relative to the total weight of the copolymer or terpolymer. The para-alkylstyrene is preferably para-methylstyrene. In addition, the terpolymer of the present invention will have from 0.20 mol % to 3.0 mol % of a halogenated monomer units, such as para-bromomethylstyrene, in one embodiment, and from 0.3 mol % to 2.5 mol % in yet another embodiment, and up to 5.0 mol % in yet another embodiment, and at least 0.05 mol % in yet another embodiment relative to the total number of moles of monomer units.

In certain formulations, low levels of either para-bromoalkylstyrene and/or para-alkylstyrene may be used. In one embodiment, para-alkylstyrene (preferably para-methylstyrene) is from 5 wt % to 15 wt % of the copolymer or terpolymer, relative to the total weight of the copolymer or terpolymer. In another embodiment, the para-methylstyrene is from 5 wt % to 10 wt % of the copolymer or terpolymer. In another embodiment, the halogenated compound, such as para-bromomethylstyrene is from 0.50 mol % to 2.0 mol % of the terpolymer. In yet another embodiment, it is from 0.5 mol % to 1.5 mol % of the terpolymer.

Rubber Components

Compositions suitable for tire treads and/or sidewalls include a primary rubber component in conjunction with the elastomeric component described above. The primary rubber component of the elastomer composition is present in the elastomeric composition in a range from 50 to 95 phr in one embodiment, from 50 to 80 phr in another embodiment, and from 50 to 70 in yet another embodiment. The primary rubber component of the present blend compositions are selected from natural rubbers, polyisoprene rubber, styrene butadiene rubber (SBR), polybutadiene rubber, isoprene butadiene rubber (IBR), styrene isoprene butadiene rubber (SIBR), butyl rubber, halogenated butyl rubber, and mixtures thereof.

So called “butyl rubber” and “halogenated butyl rubber” are typically copolymers of isobutylene derived monomer units and multiolefin derived monomer units such as isoprene. The butyl rubber can be halogenated to form chloro- or bromobutyl rubber. These rubbers are common in the art and described in, for example, RUBBER TECHNOLOGY 284-321 (Maurice Morton ed., Chapman & Hall 1995) (1987). In an alternate embodiment of the invention, butyl and halogenated butyl rubbers are absent from the composition used to make, for example, automotive tire treads and sidewalls. By “absent”, it is meant that those rubbers are not added to the composition during any portion of the process of blending the components, and/or forming the end article such as an automotive tire component. Thus, in this embodiment, the primary rubber component is selected from natural rubbers, polyisoprene rubber, styrene butadiene rubber (SBR), polybutadiene rubber, isoprene butadiene rubber (IBR), styrene isoprene butadiene rubber (SIBR), and mixtures thereof.

An embodiment of the primary rubber component present is natural rubber. Natural rubbers are described in detail by Subramaniam in RUBBER TECHNOLOGY, 179-208. Desirable embodiments of the natural rubbers of the present invention are selected from the group consisting of Malaysian rubber such as SMR CV, SMR 5, SMR 10, SMR 20, and SMR 50 and mixtures thereof, wherein the natural rubbers have a Mooney viscosity at 100° C. (ML 1+4) of from 30 to 120, more preferably from 40 to 65. The Mooney viscosity test referred to herein is in accordance with ASTM D-1646.

A secondary rubber component can also be present in the elastomeric composition of the invention. The secondary rubber is present in the elastomeric composition in an amount greater than or equal to 0 phr in one embodiment, and less than 50 phr in another embodiment. Desirably, the secondary rubber is present in the elastomeric composition from 0 to 40 phr in one embodiment, from 1 to 40 phr in another embodiment, from 5 to 35 phr in yet another embodiment, and from 10 to 30 phr in yet another embodiment. The secondary rubber component is selected from polybutadiene, polyisoprene, styrene-butadiene rubber, and styrene-isoprene-butadiene rubber, isoprene-butadiene rubber, ethylene-propylene diene (EPDM) rubber, and high cis-polybutadiene. Some commercial examples of secondary rubbers useful in the present invention are NATSYN™ (Goodyear Chemical Company), and BUDENE™ 1207 or BR 1207 (Goodyear Chemical Company). A desirable secondary rubber component is high cis-polybutadiene (cis-BR). By “cis-polybutadiene” or “high cis-polybutadiene”, it is meant that 1,4-cis polybutadiene is used, wherein the amount of cis component is at least 95%. An example of high cis-polybutadiene commercial products used in the covulcanized composition BUDENE™ 1207.

Filler

The elastomeric composition may have one or more filler components such as calcium carbonate, clay, silica, talc, titanium dioxide, and carbon black. In one embodiment, the filler is carbon black or modified carbon black. In another embodiment, the filler is a blend of carbon black and silica. The preferred filler is reinforcing grade carbon black present at a level of from 10 to 100 phr of the blend, more preferably from 30 to 80 phr. Useful grades of carbon black, as described in RUBBER TECHNOLOGY, 59-85, range from N110 to N990. More desirably, embodiments of the carbon black useful in, for example, tire treads are N229, N351, N339, N220, N234 and N110 provided in ASTM (D3037, D1510, and D3765). Embodiments of the carbon black useful in, for example, sidewalls in tires, are N330, N351, N550, N650, N660, and N762.

Processing Aid

A processing aid may also be present in the composition of the invention. Processing aids include, but are not limited to, plasticizers, tackifiers, extenders, chemical conditioners, homogenizing agents and peptizers such as mercaptans, petroleum and vulcanized vegetable oils, waxes, resins, rosins, and the like. The aid is typically present from 1 to 70 phr in one embodiment, from 5 to 60 phr in another embodiment, and from 10 to 50 phr in yet another embodiment. Some commercial examples of processing aids are SUNDEX™ (Sun Chemicals) and FLEXON™ (ExxonMobil Chemical Company).

Curing Agents and Accelerators

The compositions produced in accordance with the present invention typically contain other components and additives customarily used in rubber mixes, such as effective amounts of other nondiscolored and nondiscoloring processing aids, pigments, accelerators, cross-linking and curing materials, antioxidants, antiozonants, fillers and naphthenic, aromatic or paraffinic extender oils if the presence of an extension oil is desired. Accelerators include amines, guanidines, thioureas, thiazoles, thiurams, sulfenamides, sulfenimides, thiocarbamates, xanthates, and the like. Cross-linking and curing agents include sulfur, zinc oxide, and fatty acids. Peroxide cure systems may also be used.

Generally, polymer blends, for example, those used to produce tires, are crosslinked. It is known that the physical properties, performance characteristics, and durability of vulcanized rubber compounds are directly related to the number (crosslink density) and type of crosslinks formed during the vulcanization reaction. (See, e.g., Helt et al., The Post Vulcanization Stabilization for NR in RUBBER WORLD, 18-23 (1991). Generally, polymer blends may be crosslinked by adding curative molecules, for example sulfur, metal oxides, organometallic compounds, radical initiators, etc. followed by heating. In particular, the following metal oxides are common curatives that will function in the present invention: ZnO, CaO, MgO, Al₂O₃, CrO₃, FeO, Fe₂O₃, and NiO. These metal oxides can be used in conjunction with the corresponding metal stearate complex, or with stearic acid, and either a sulfur compound or an alkylperoxide compound. (See also, Formulation Design and Curing Characteristics of NBR Mixes for Seals, RUBBER WORLD 25-30 (1993). This method may be accelerated and is often used for the vulcanization of elastomer blends.

The acceleration of the cure process is accomplished by adding to the composition an amount of an accelerant, often an organic compound. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), hexamethylene-1,6-bisthiosulfate disodium salt dihydrate (sold commercially as DURALINK™ HTS by Flexsys), 2-(morpholinothio) benzothiazole (MBS or MOR), blends of 90% MOR and 10% MBTS (MOR 90), N-tertiarybutyl-2-benzothiazole sulfenamide (TBBS), and N-oxydiethylene thiocarbamyl-N-oxydiethylene sulfonamide (OTOS), zinc 2-ethyl hexanoate (ZEH), N,N′-diethylthiourea (thiourea) (sold commercially by R. T. Vanderbilt).

The present invention provides improved elastomeric compositions comprising a copolymer of a C₄ to C₇ isoolefin and a para-alkylstyrene, natural rubber, and optionally a processing aid and coupling agents. In order to improve certain physical properties of the composition, a secondary rubber component may also be present. These compositions exhibit improved properties including improved abrasion resistance, reduced cut growth, improved adhesion, reduced heat build-up, and retention of mechanical properties during severe heat build-up conditions such as those experienced in “run-flat” tires and engine mounts for transportation vehicles. Thus, the compositions of the present invention are useful in automotive tire sidewalls and tire treads, as well as hoses, antivibrational mounts, shoe soles, and other articles.

One embodiment of the elastomeric composition comprises from 50 to 95 phr natural rubber, from 5 to 40 phr of a copolymer of a C₄ to C₇ isoolefin and a para-alkylstyrene, and from 0 to 40 phr of polybutadiene. In another embodiment, the copolymer also includes para-bromomethylstyrene monomer derived units to form a terpolymer, the para-bromomethylstyrene is present from 0.2 mol % to 3.0 mol % relative to the terpolymer. In yet another embodiment, the composition includes carbon black.

The natural rubber is present from 50 to 80 phr in another embodiment, and from 50 to 70 phr in yet another embodiment, while the polybutadiene is present from 5 to 35 phr in another embodiment, and from 10 to 30 phr in yet another embodiment. The polybutadiene is a high cis-polybutadiene in a further embodiment. Also, the copolymer of a C₄ to C₇ isoolefin and a para-alkylstyrene is present from 10 to 35 phr in one embodiment of the composition.

In yet another embodiment, the composition also includes at least one curing agent such as a metal oxide and organic acid such as stearic acid or other fatty acid common in the art, and may also include elemental sulfur in another embodiment. The cure agent or cure agents may be present from 0.1 to 10 phr in one embodiment. Upon heating or other appropriate means known in the art, the composition can be cured to form a tire tread in one embodiment, and a tire sidewall in yet another embodiment.

In an alternate embodiment, the composition of the invention consists essentially of from 50 to 95 phr natural rubber, from 5 to 40 phr of a copolymer of a C₄ to C₇ isoolefin and a para-alkylstyrene, and from 0 to 40 phr of polybutadiene. In another embodiment, the copolymer also includes para-bromomethylstyrene monomer derived units to form a terpolymer, the para-bromomethylstyrene being present from 0.2 mol % to 3.0 mol % relative to the terpolymer. In yet another embodiment, the composition includes carbon black.

In an alternate embodiment, the composition of the invention consists essentially of from 50 to 95 phr natural rubber, from 5 to 40 phr of a terpolymer of a C₄ to C₇ isoolefin, para-alkylstyrene, and para-bromoalkylstyrene, from 0 to 40 phr of polybutadiene, a filler, and a cure agent. The para-bromomethylstyrene may be present from 0.2 mol % to 3.0 mol % relative to the terpolymer. The filler is desirably carbon black, or blends of silica and carbon black.

Another embodiment of the invention includes an automotive tire tread or tire sidewall formed from a cured elastomeric composition comprising from 50 to 80 phr natural rubber; from 20 to 40 phr of a terpolymer of a C₄ to C₇ isoolefin, para-methylstyrene and para-bromomethylstyrene; from 5 to 30 phr of high cis-polybutadiene, and a filler selected from carbon black and silica; wherein the cured composition has a DIN abrasion index of up to 130 in one embodiment, and at least 110 in another embodiment; and a Tangent Delta value at −30° C. up to 0.70, and at least 0.40 in another embodiment.

The materials are mixed by conventional means known to those skilled in the art, in a single step or in stages. For example, the elastomers of this invention can be processed in one step. In one embodiment, the carbon black is added in a different stage from zinc oxide and other cure activators and accelerators. In another embodiment, antioxidants, antiozonants and processing materials are added in a stage after the carbon black has been processed with the elastomeric composition, and zinc oxide is added at a final stage to maximize compound modulus. Thus, a two to three (or more) stage processing sequence is preferred. Additional stages may involve incremental additions of filler and processing aids.

The compositions may be vulcanized by subjecting them to heat or radiation according to any conventional vulcanization process. Typically, the vulcanization is conducted at a temperature ranging from about 100° C. to about 250° C. in one embodiment, from 150° C. to 200° C. in another embodiment, for about 1 to 150 minutes.

Suitable elastomeric compositions for such articles as tire treads may be prepared by using conventional mixing techniques including, for example, kneading, roller milling, extruder mixing, internal mixing (such as with a Banbury™ mixer), etc. The sequence of mixing and temperatures employed are well known to those skilled in rubber compounding, the objective being the dispersion of fillers, activator, and curatives in the rubber matrix without excessive heat buildup. A useful mixing procedure utilizes a Banbury™ mixer in which the elastomeric components, carbon black, and other components are mixed for the desired time or to a particular temperature to achieve adequate dispersion of the ingredients.

The final cured elastomeric compositions of the invention can be characterized by several properties such as, for example, Mooney viscosity, DIN abrasion values and the Tangent Delta values. In one embodiment of the composition, the Mooney viscosity of the composition is in the range from 40 to 80. In another embodiment, the cured composition has a Tangent Delta at −60° C. in the range from 0.30 to 0.50, and from 0.25 to 0.45 in another embodiment, and from greater than 0.2 in yet another embodiment, and finally, in the range from 0.2 to 0.5 in yet another embodiment. The Tangent Delta at −30° C. may be in the range from 0.40 to 0.60 in another embodiment, and up to 0.60 in yet another embodiment, and up to 0.65 in yet another embodiment, and up to 0.70 in yet another embodiment. The Tangent Delta at 0° C. may be in the range from 0.20 to 0.30 in yet another embodiment, and up to 0.30 in another embodiment, and up to 0.35 in yet another embodiment, and up to 0.40 in yet another embodiment.

Also, the cured composition may have an DIN abrasion index of greater than 100 in one embodiment, and greater than 110 in yet another embodiment, and greater than 115 in another embodiment, and less than 150 in yet another embodiment, and less than 130 in another embodiment, and less than 125 in another embodiment, wherein a desirable embodiment may include any upper limit in combination with any lower limit of DIN abrasion. For example, one desirable range in the DIN abrasion index for the cured composition of the invention may be from 100 to 150, and from 100 to 130 in another embodiment, and from 110 to 150 in yet another embodiment, and from 115 to 140 in yet another embodiment. The final cured elastomeric composition has improved Tangent Delta values from −20° C. to −40° C. relative to compositions of natural rubber not including BIMS and polybutadiene, the improvement being an increase of the Tangent Delta values in those ranges, which can be used as a predictor of tire tread winter traction properties.

The elastomeric compositions of the present invention may be used for the production of treads for any type of rubber tires, for example, motor vehicle tires, such as passenger automobile tires, truck tires, motorcycle tires, and the like. The tires typically comprise an outer surface having a tread portion and sidewalls. The composition of the present invention may be used to produce at least a part of the tread portion or sidewall. The tire, including the tread portion, may be produced by any conventional method. The elastomeric composition is also useful for any application where high damping and/or high abrasion resistance is desired such as in vibration mounts, shoe soles, hoses, belts, windshield wipers, and other engineered elastomeric articles. These and other useful articles that can be made from the compositions of the invention are disclosed in, for example, THE VANDERBILT RUBBER HANDBOOK 595-772 (Robert F. Ohm ed., R. T. Vanderbilt Company, Inc. 1990), wherein example formulations suitable for passenger tire sidewalls, tread, truck tread and carcass are disclosed.

Test Methods

Cure properties were measured using a MDR 2000 at the indicated temperature and 0.5 degree arc. Test specimens were cured at the indicated temperature, typically from 150° C. to 160° C., for a time (in minutes) corresponding to T90+appropriate mold lag. When possible, standard ASTM tests were used to determine the cured compound physical properties. Stress/strain properties (tensile strength, elongation at break, modulus values, energy to break) were measured at room temperature using an Instron 4202 or Instron 4204. Shore A hardness was measured at room temperature by using a Zwick Duromatic. Abrasion loss was determined at room temperature by weight difference by using an APH-40 Abrasion Tester with rotating sample holder (5 N counter balance) and rotating drum. Weight losses were indexed to that of the standard DIN compound with lower losses indicative of a higher DIN abrasion resistance index. Weight losses were indexed to that of the standard DIN compound with lower losses indicative of a higher DIN abrasion resistance index. The weight losses can be measured with an error of ±5%.

Temperature-dependent (−80° C. to 60° C.) dynamic properties (E*, E′, E″ and Tangent Delta) were obtained using a Rheometrics ARES. A rectangular torsion sample geometry was tested at 1 Hz and 2% strain. Values of E″ or Tangent Delta measured in the range from −10C to 10° C. in laboratory dynamic testing can be used as predictors of tire wet traction for carbon black-filled BR/sSBR (styrene-butadiene rubber) compounds. The Tangent Delta values are measured with an error of ±5%, while the temperature is measured with an error of 1° C.

### EXAMPLES

Below are examples of various compositions and methods of forming the composition of the invention. The following examples are by no means meant to be limiting of the invention, but are representative only.

Samples 1-12 are master batch elastomeric compositions prepared by conventional mixing techniques, as shown in Table 1. The elastomer component is EXXPRO™ 3745 grade (ExxonMobil Chemical Company) having a para-methylstyrene content of from 7.5±1 wt %, a para-bromomethylstyrene (mol %) content of 1.2±0.1 mol % and Mooney Viscosity(ML(1±8)125° C.) of 45±5. The secondary rubber component is high cis-polybutadiene, commercially sold as BUDENE™ 1207 (Goodyear Chemical Company). The primary rubber component is SMR20 natural rubber.

The remaining ingredients as shown in Table 2 are carbon black N234 (Harwick Chemical Company), SUNDEX™ 8125 (Sun Chemical Company) a processing oil to aid in mixing, stearic acid (Witco Chemical Company), SANTOFLEX™ 13 (N-1,3-dimethylbutyl-N′-phenyl-p-phenylene diamine, Flexsys Chemical Company), Agerite Resin D (R. T. Vanderbilt Company), KADOX™ 930C (zinc oxide, Zinc Corporation of America), sulfur (Sunbelt Chemicals), and TBBS (N-tertiary-butyl-2-benzothiazole-sulfenamide, Flexsys Chemical Company).

The materials are mixed by conventional means known to those skilled in the art, in three steps or three stages. In one embodiment, the carbon black is added in a different stage from zinc oxide and other cure activators and accelerators. In a more preferred embodiment, antioxidants, antiozonants and processing materials are added in a stage after carbon black have been processed with the rubber, and zinc oxide is added at a final stage. Thus, a three (or more) stage processing sequence is preferred. Additional stages may involve incremental additions of filler and processing aids.

The test compositions were tested for cure characteristics, hardness and tensile properties. The values “MH-ML” used here and throughout the description refer to “maximum torque” minus “minimum torque”, respectively. The “MS” value is the Mooney scorch value, the “ML(1+4)” value is the Mooney viscosity value. The values of “T” are cure times in minutes, and “Ts″ is scorch time”. The results are presented in Tables 3-6.

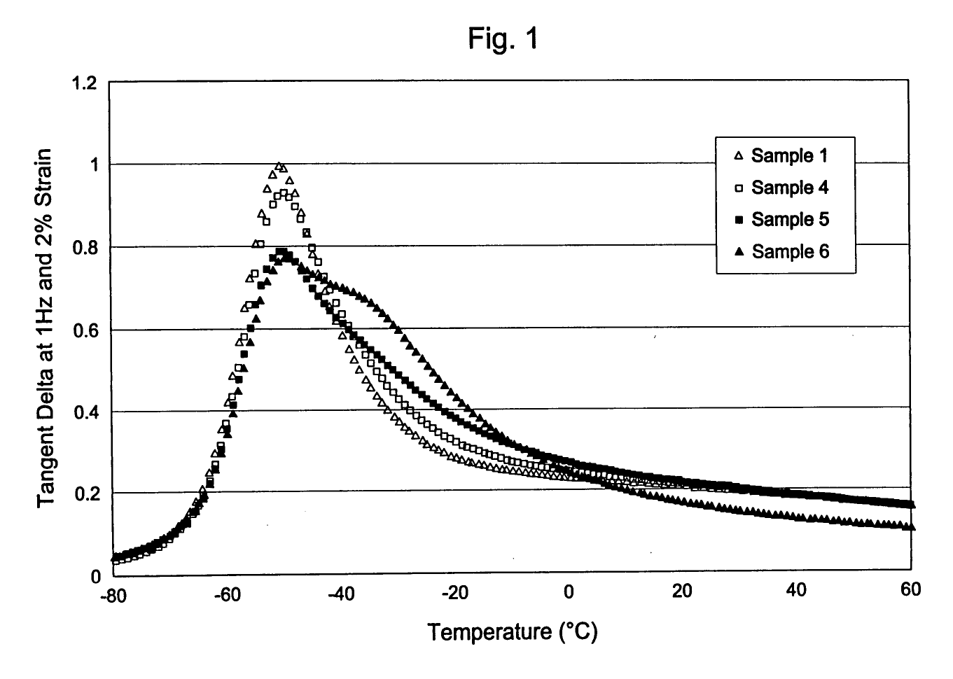

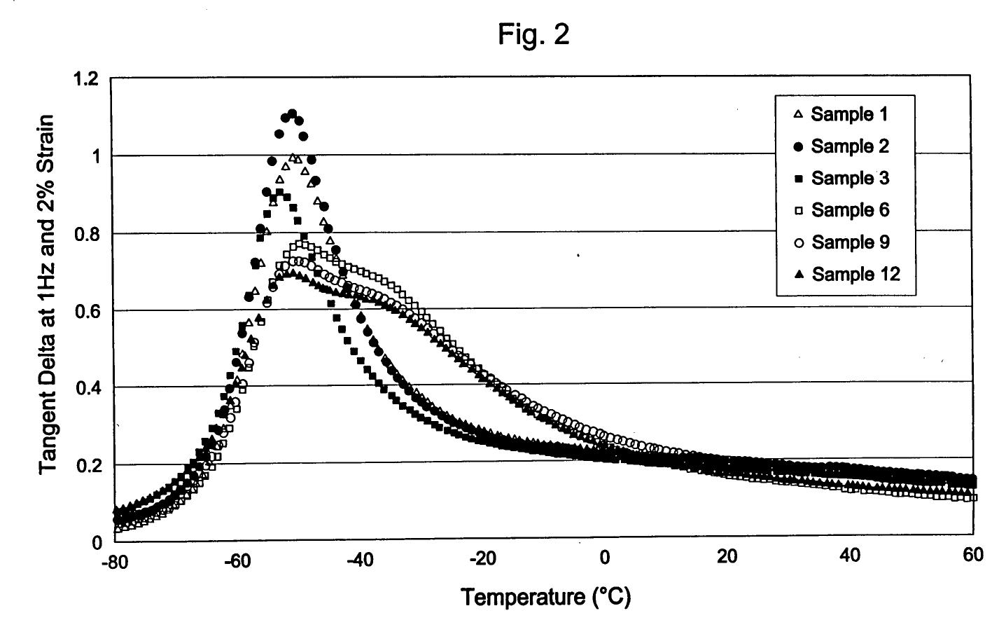

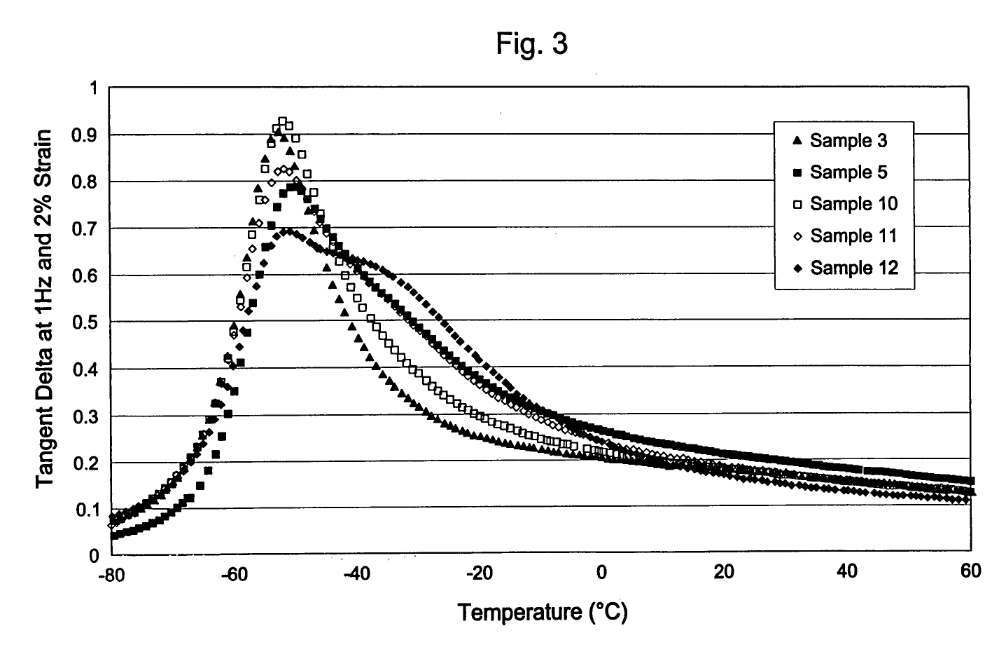

The Samples 4-12 are compared to control Samples 1-3. Samples 9, 11, and 12 exemplify particularly desirable characteristics relative to the control samples. In particular, it is advantageous to maintain the DIN abrasion values of about 100 to 130 as shown in Table 3, while increasing the Tangent Delta at −30° C. and decreasing the Tangent Delta value at −60° C. to improve cold weather traction in, for example, tire treads. This trend is indeed apparent when comparing the control Samples 1-3 in FIGS. 1-3 with Samples 9, 11 and 12, where the Tangent Delta values advantageously increase in the −20° C. to −40° C. region of the plot and the Tangent Delta values advantageously decrease around the −60° C. region. Increased Tangent Delta values at from −20° C. to −40° C. are known in the art to indicate better cold weather traction for a tire.

More specifically, Sample 1 is the control compound. Sample 2 and 3 contain varying levels of polybutadiene, and do not contain the elastomeric component, a terpolymer of a C₄ to C₇ isoolefin, and a para-alkylstyrene, and para-bromoalkylstyrene (BIMS). Abrasion resistance values increase with increasing polybutadiene, but Tangent Delta at −60° C. values increase and Tangent Delta at −30° C. values decrease with increasing polybutadiene compared to the control Sample 1. Samples 4, 5, and 6 contain varying phr of an elastomeric component (BIMS), and contain no secondary rubber component. Tangent Delta at −60° C. values decrease and Tangent Delta at −30° C. values increase with increasing BIMS, but abrasion resistance values decrease with increasing BIMS compared to the control Sample 1.

Samples 7, 8, 9, 10, 11, and 12 contain varying levels of a BIMS elastomeric component, and also contain varying levels of the secondary rubber polybutadiene. For Compositions 8, 9, and 12, abrasion resistance values are higher, Tangent Delta at −60° C. values are equal to or lower, and Tangent Delta at −30° C. values are higher than the control Sample 1. For Compositions 10, 11, and 12, abrasion resistance values are equal to or higher, Tangent Delta at −60° C. values are equal to or lower, and Tangent Delta at −30° C. values are higher than Sample 2. Also, for Samples 7, 8, 9, 10, 11, and 12, Tangent Delta at −60° C. values are lower, and Tangent Delta at −30° C. values are higher than Sample 3.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

TABLE 1
Sample Components

| | Sample | | | | | | | | | | | |
|---|---|---|---|---|---|---|---|---|---|---|---|---|
| Component | 1 | 2 | 3 | 4 | 5 | 6 | 7 | 8 | 9 | 10 | 11 | 12 |
| BIMS | 0 | 0 | 0 | 10 | 20 | 30 | 10 | 20 | 30 | 10 | 20 | 30 |
| high cis- | 0 | 10 | 20 | 0 | 0 | 0 | 10 | 10 | 10 | 20 | 20 | 20 |
| poly- | | | | | | | | | | | | |
| butadiene | | | | | | | | | | | | |
| natural | 100 | 90 | 80 | 90 | 80 | 70 | 80 | 70 | 60 | 70 | 60 | 50 |
| rubber | | | | | | | | | | | | |

TABLE 2
Additional Components in Samples 1 through 12

| Ingredient | phr |
|---|---|
| Carbon black, N234 | 60 |
| Sundex ™ 8125 (processing aid) | 30 |
| Stearic Acid | 1 |
| Santoflex ™ 13 (antioxidant) | 1.5 |
| Agerite ™ Resin D (antioxidant) | 1 |
| Kadox ™ 930 (zinc oxide) | 1 |
| Sulfur | 1 |
| TBBS | 1.5 |

TABLE 3
Variation of Sample Components; No BIMS present

| Property | 1 | 2 | 3 |
|---|---|---|---|
| CURE | | | |
| Mooney Scorch @ 135° C., t10 | 15.3 | 15.8 | 16.2 |
| MH-ML | 10.3 | 11.1 | 11.1 |
| ts2 | 2.9 | 3.0 | 3.3 |
| t50 | 3.3 | 3.5 | 3.8 |
| t90 | 4.3 | 4.6 | 5.0 |
| MECHANICAL | | | |
| Hardness Shore A | 59 | 57 | 52 |
| Abrasion Index | 97 | 114 | 129 |
| 100% Modulus (MPa) | 1.6 | 1.7 | 1.7 |
| 300% Modulus (MPa) | 8.9 | 8.9 | 8.6 |
| Tensile (MPa) | 20.8 | 21.2 | 22.4 |
| % Elongation | 528 | 540 | 554 |
| DYNAMIC | | | |
| Tan Delta @ 60° C. | 0.42 | 0.46 | 0.49 |
| E* @ −30° C. × 10 (MPa) | 18.66 | 13.57 | 17.61 |
| 1/E @ −30° C. (MPa) | 0.0536 | 0.0737 | 0.0568 |
| Tan Delta @ −30° C. | 0.37 | 0.36 | 0.31 |
| E″ @ 0° C. (MPa) | 2.00 | 1.62 | 2.03 |
| Tan Delta @ 0° C. | 0.23 | 0.22 | 0.21 |
| E* @ 60° C. (MPa) | 5.12 | 4.55 | 6.35 |
| Tan Delta @ 60° C. | 0.15 | 0.15 | 0.13 |

TABLE 4
Variation of Sample Components;
No cis-polybutadiene present

| Property | 4 | 5 | 6 |
|---|---|---|---|
| CURE | | | |
| Mooney Scorch @ 135° C., t10 | 16.9 | 20.0 | 20.7 |
| MH-ML | 9.4 | 8.7 | 7.8 |
| ts2 | 3.3 | 3.4 | 3.7 |
| t50 | 3.8 | 4.0 | 4.2 |
| t90 | 5.1 | 5.4 | 5.9 |
| MECHANICAL | | | |
| Hardness Shore A | 58 | 58 | 59 |
| Abrasion Index | 91 | 87 | 84 |
| 100% Modulus (MPa) | 1.7 | 2.0 | 2.3 |
| 300% Modulus (MPa) | 8.2 | 8.3 | 8.6 |
| Tensile (MPa) | 20.4 | 18.1 | 15.9 |
| % Elongation | 552 | 538 | 494 |
| DYNAMIC | | | |
| Tan Delta @ −60° C. | 0.37 | 0.35 | 0.34 |
| E* @ −30° C. × 10 (MPa) | 19.23 | 26.67 | 24.37 |
| 1/E @ −30° C. (MPa) | 0.052 | 0.0375 | 0.041 |
| Tan Delta @ −30° C. | 0.43 | 0.48 | 0.60 |
| E″ @ 0° C. (MPa) | 1.91 | 2.33 | 1.70 |
| Tan Delta @ 0° C. | 0.24 | 0.26 | 0.24 |
| E* @ 60° C. (MPa) | 4.37 | 4.46 | 4.12 |
| Tan Delta @ 60° C. | 0.15 | 0.15 | 0.10 |

TABLE 5
Variation of Sample Components;
10 phr cis-polybutadiene

| Property | 7 | 8 | 9 |
|---|---|---|---|
| CURE | | | |
| Mooney Scorch @ 135° C., t10 | 18.4 | 20.4 | 21.0 |
| MH-ML | 10.1 | 9.3 | 8.5 |
| ts2 | 3.4 | 3.7 | 3.9 |
| t50 | 3.9 | 4.4 | 4.6 |
| t90 | 5.3 | 6.0 | 6.5 |
| MECHANICAL | | | |
| Hardness Shore A | 57 | 55 | 57 |
| Abrasion Index | 105 | 100 | 105 |
| 100% Modulus (MPa) | 1.7 | 2.1 | 2.7 |
| 300% Modulus (MPa) | 8.7 | 8.8 | 9.6 |
| Tensile (MPa) | 20.6 | 19.2 | 17.8 |
| % Elongation | 552 | 535 | 495 |
| DYNAMIC | | | |
| Tan Delta @ −60° C. | 0.44 | 0.42 | 0.36 |
| E* @ −30° C. × 10 (MPa) | 18.79 | 20.74 | 24.16 |
| 1/E @ −30° C. (MPa) | 0.053 | 0.0482 | 0.0414 |
| Tan Delta @ −30° C. | 0.39 | 0.49 | 0.56 |
| E″ @ 0° C. (MPa) | 2.00 | 1.99 | 1.92 |
| Tan Delta @ 0°C. | 0.23 | 0.27 | 0.26 |
| E* @ 60° C. (MPa) | 5.12 | 4.05 | 3.97 |
| Tan Delta @ 60° C. | 0.14 | 0.16 | 0.14 |

TABLE 6
Variation of Sample Components;
20 phr cis-polybutadiene

| Property | 10 | 11 | 12 |
|---|---|---|---|
| CURE | | | |
| Mooney Scorch @ 135° C., t10 | 18.3 | 21.7 | 19.7 |
| MH-ML | 10.3 | 9.5 | 8.6 |
| ts2 | 3.6 | 3.9 | 3.9 |
| t50 | 4.1 | 4.7 | 4.6 |
| t90 | 5.7 | 6.6 | 7.0 |
| MECHANICAL | | | |
| Hardness Shore A | 60 | 60 | 60 |
| Abrasion Index | 121 | 115 | 115 |
| 100% Modulus (MPa) | 1.9 | 1.9 | 2.7 |
| 300% Modulus (MPa) | 8.5 | 8.6 | 10.4 |
| Tensile (MPa) | 19.7 | 18.9 | 17.4 |
| % Elongation | 558 | 547 | 470 |
| DYNAMIC | | | |
| Tan Delta @ −60° C. | 0.48 | 0.47 | 0.41 |
| E* @ −30° C. × 10 (MPa) | 16.68 | 17.38 | 22.18 |
| 1/E @ −30° C. (MPa) | 0.0599 | 0.0575 | 0.0451 |
| Tan Delta @ −30° C. | 0.39 | 0.48 | 0.55 |
| E″ @ 0° C. (MPa) | 1.77 | 1.68 | 1.71 |
| Tan Delta @ 0° C. | 0.22 | 0.23 | 0.24 |
| E* @ 60° C. (MPa) | 5.10 | 4.41 | 4.13 |
| Tan Delta @ 60° C. | 0.13 | 0.13 | 0.11 |

We claim:

1. An elastomeric composition comprising from 50 to 95 phr natural rubber;
from 5 to 40 phr of a copolymer of a C₄ to C₇ isoolefin and a para-alkylstyrene; and from 0 to 40 phr of polybutadiene.

2. The composition of claim 1, wherein the copolymer also includes para-bromomethylstyrene monomer derived units to form a terpolymer, the para-bromomethylstyrene is present from 0.2 mol % to 3.0 mol % relative to the terpolymer.

3. The composition of claim 1, also comprising carbon black.

4. The composition of claim 1, wherein the natural rubber is present from 50 to 80 phr.

5. The composition of claim 1, wherein the natural rubber is present from 50 to 70 phr.

6. The composition of claim 1, wherein the polybutadiene is present from 5 to 35 phr.

7. The composition of claim 1, wherein butyl rubber and halogenated butyl rubber are absent.

8. The composition of claim 1, wherein the polybutadiene is a high cis-polybutadiene.

9. The composition of claim 1, wherein the copolymer of a C₄ to C₇ isoolefin and a para-alkylstyrene is present from 10 to 35 phr.

10. The composition of claim 1, wherein the composition also includes a curing agent.

11. The composition of claim 1, wherein the composition is formed into a tire tread.

12. The composition of claim 1, wherein the composition is formed into a tire sidewall.

13. A cured elastomeric composition comprising from 50 to 95 phr natural rubber; from 5 to 40 phr of a copolymer of a C₄ to C₇ isoolefin and a para-alkylstyrene; and from 1 to 40 phr of polybutadiene.

14. The composition of claim 13, wherein the copolymer also includes para-bromomethylstyrene monomer derived units to form a terpolymer, the para-bromomethylstyrene is present from 0.2 mol % to 3.0 mol % relative to the terpolymer.

15. The composition of claim 13, also comprising carbon black.

16. The composition of claim 13, wherein the natural rubber is present from 50 to 80 phr.

17. The composition of claim 13, wherein the natural rubber is present from 50 to 70 phr.

18. The composition of claim 13, wherein the polybutadiene is present from 5 to 35 phr.

19. The composition of claim 13, wherein the polybutadiene is present from 10 to 30 phr.

20. The composition of claim 13, wherein the polybutadiene is a high cis-polybutadiene.

21. The composition of claim 13, wherein the copolymer of a C₄ to C₇ isoolefin and a para-alkylstyrene is present from 10 to 35 phr.

22. The composition of claim 13, wherein the composition also includes a curing agent.

23. The composition of claim 13, wherein the composition is a tire tread.

24. The composition of claim 13, wherein the composition is a tire sidewall.

25. The composition of claim 13, wherein the cured composition has a Tangent Delta at −60° C. in the range from 0.30 to 0.50.

26. The composition of claim 13, wherein the cured composition has a Tangent Delta at −30° C. in the range from 0.40 to 0.6.

27. The composition of claim 13, wherein the cured composition has a DIN abrasion index of from 100 to 125.

28. An elastomeric composition comprising from 50 to 95 phr of a primary rubber component; from 5 to 40 phr of a copolymer of a C₄ to C₇ isoolefin and a para-alkylstyrene; and from 0 to 40 phr of a secondary rubber component.

29. The composition of claim 28, wherein the copolymer also includes para-bromomethylstyrene monomer derived units to form a terpolymer, the para-bromomethylstyrene is present from 0.2 mol % to 3.0 mol % relative to the terpolymer; wherein the cured composition has a DIN abrasion index of greater than 100.

30. The composition of claim 28, also comprising carbon black.

31. The composition of claim 28, wherein the primary rubber component is present from 50 to 80 phr.

32. The composition of claim 28, wherein the primary rubber component is present from 50 to 70 phr.

33. The composition of claim 28, wherein the primary rubber component is selected from natural rubbers, polyisoprene rubber, styrene butadiene rubber, polybutadiene rubber, isoprene butadiene rubber, styrene isoprene butadiene rubber, butyl rubber, halobutyl rubber and mixtures thereof.

34. The composition of claim 28, wherein the secondary rubber component is present from 5 to 35 phr.

35. The composition of claim 28, wherein the secondary rubber component is present from 10 to 30 phr.

36. The composition of claim 28, wherein the secondary rubber component is high cis-polybutadiene.

37. The composition of claim 28, wherein the copolymer of a C₄ to C₇ isoolefin and a para-alkylstyrene is present from 10 to 35 phr.

38. The composition of claim 28, wherein the composition also includes a curing agent.

39. The composition of claim 28, wherein the composition is a tire tread.

40. The composition of claim 28, wherein the composition is a tire sidewall.

41. An automotive tire tread or tire sidewall formed from a cured elastomeric composition comprising from 50 to 80 phr natural rubber; from 10 to 40 phr of a terpolymer of a C₄ to C₇ isoolefin, para-methylstyrene and para-bromomethylstyrene; from 5 to 30 phr of high cis-polybutadiene; and a filler selected from carbon black and silica; wherein the cured composition has a DIN abrasion index of greater than 100, and a Tangent Delta value at −30° C. up to 0.70.

42. The automotive tire tread or tire sidewall of claim 41, wherein the natural rubber is present from 50 to 70 phr.

43. The automotive tire tread or tire sidewall of claim 41, wherein the polybutadiene is present from 10 to 25 phr.

44. The automotive tire tread or tire sidewall of claim 41, wherein the polybutadiene is a high cis-polybutadiene.

45. The automotive tire tread or tire sidewall of claim 41, wherein the composition also includes a curing agent.

46. The automotive tire tread or tire sidewall of claim 41, wherein the filler is present from 10 to 100 phr.

47. The automotive tire tread or tire sidewall of claim 41, wherein the filler is carbon black.

48. The automotive tire tread or tire sidewall of claim 41, wherein the Tangent Delta value at 0° C. is up to 0.40.

49. The automotive tire tread or tire sidewall of claim 41, wherein the para-bromomethylstyrene is present in the terpolymer from 0.2 mole % to 3.0 mole % based on the terpolymer.
